(19) United States
(12) Patent Application Publication
(10) Pub. No.: US 2003/0235315 A1
(43) Pub. Date: Dec. 25, 2003

(54) Digital microphone

(76) Inventor: Gord Reesor, Ottawa (CA)

Correspondence Address: MARKS & CLERK, P.O. BOX 957, STATION B, OTTAWA, ON, K1P 5S7, CA

(21) Appl. No.: 10/379,562

(22) Filed: Mar. 6, 2003

(30) Foreign Application Priority Data
Mar. 7, 2002 (GB) 0205352.8

(51) Int. Cl. H04R 3/00

(52) U.S. Cl. 381/115; 381/111

(57) ABSTRACT

A digital microphone has a transducer for generating an analog signal representing an acoustic signal, and a single bit sigma-delta modulator analog-to-digital converter of order greater than one for generating a digital output signal from said analog signal in the form of a sigma-delta modulated bit stream at an oversampled rate. The digital microphone avoids the need to include digital decimation and filtering circuits within the microphone housing and thus lends itself better to integration technologies.

### BACKGROUND OF THE INVENTION

1. Field of the Invention

This invention relates to the field of sound transducers, and in particular to a digital microphone for converting sound waves to a digital signal for use in telephony and other applications.

2. Background of the Invention

A microphone is a device for converting a sound wave into an output signal representative of the sound wave. Traditionally, microphones have been analog in design, relying, for example, on piezo-electric crystals or capacitors to generate an analog output signal representative of the pressure wave striking the active surface of the microphone. A common microphone of this type is the Electret microphone where the plates of a capacitor are given a permanent electrical charge. When a sound wave causes the charged diaphragm plate to vibrate, the voltage across the plates changes, creating an analog signal that can be amplified and transmitted to the recording device.

Since sound processing now occurs largely in the digital domain, historically the analog signal produced by the microphone has been digitized by passing it through an analog-to-digital converter. More recently, it has been realized that it would be desirable to produce a microphone unit that directly outputs a digital signal. For example, U.S. Pat. No. 5,886,656 to Feste describes a device where analog inputs are input from a microphone, amplified, and converted to an “intermediate” digital signal. This intermediate signal is then decimated to a lower sample rate, filtered with a digital filter to remove quantization noise, and finally passed through a parallel-to-serial converter to provide a digital serial output signal.

However, Feste et al. proposes the use of the “multi-bit” output type MASH structure with the decimation, digital filtering of quantization noise, and parallel-to-serial conversion included within the microphone housing. These circuits to not lend themselves to cost-effective integration with the analog components.

### SUMMARY OF THE INVENTION

According to the present invention there is provided a digital microphone comprising a digital microphone comprising a transducer for generating an analog signal representing an acoustic signal; and a single bit sigma-delta modulator analog-to-digital converter of order greater than one for generating a digital output signal from said analog signal in the form of a sigma-delta modulated bit stream at an oversampled rate.

The sigma-delta converter is a mixed signal analog and digital circuit used for analog to digital conversion, but only part of a complete analog-to-digital converter circuit. The sigma-delta modulator provides a single bit stream output at a high bit rate, e.g. N*F Hz, where N is the number of bits per sample and may be in the range of 32 to 128 typically, and F is the assumed final sample rate of the audio signal.

The sigma-delta modulator should have an order greater than one, and preferably be of high order. This enables the clock speed to be kept lower than would be possible with a first order modulator. Reduced clock speed also means less EMI (electromagnetic interference).

In a preferred embodiment, the transducer is an Electret device coupled to an amplifier, which in turn is coupled to a sigma-delta modulator with a signal limiter built into its input stage.

A sigma-delta modulator of the single bit variety as described in “A higher Order Topology for Interpolative Modulators for Oversampling A/D Converters”, Chao, Lee, and Sodini. IEEE trans Circuits and Sys,. Vol. CAS-37, pp. 309-318, March 1990, the contents of which are herein incorporated by reference, is used in the preferred embodiment.

In the inventive arrangement, the digital circuits are left to be implemented in another digital device that can implement these parts more cost effectively. The digital circuits can be implemented as part of a “system-on-chip” (SOC) digital device, which can be fabricated with lower cost per gate, deep sub-micron digital IC technology as opposed to the larger geometry analog IC technology that is more appropriate for implementation of the amplifier, limiter, and sigma-delta modulator.

Additionally, by using a single bit variety of sigma-delta modulator the need to decimate the digital “intermediate” serial bit stream is avoided as this bit stream lies in the range of say 512 Kbps to 4,096 Kbps depending upon the order of the modulator, and the performance requirements of the microphone. This is considered to be sufficiently low bit rate that decimation is more appropriately left implemented within another digital SOC device.

The digital microphone in accordance with the invention converts acoustic sound pressure to a serial digital output signal that can be used as an output to transport audio signals to other circuits without the need for digital decimation and filtering circuits contained within the digital microphone device.

The invention also provides a method of converting an acoustic input signal to a digital output signal, comprising converting said acoustic input signal to an analog electrical signal; and converting said analog electrical signal to a digital signal with the aid of a single bit sigma-delta modulator analog-to-digital converter to generate a single bit digital output signal.

### BRIEF DESCRIPTION OF THE DRAWINGS

The invention will now be described in more detail, by way of example only, with reference to the accompanying drawings, in which:

FIG. 1 is a diagram of a typical Electret microphone;

FIG. 2 is a diagram of the digital microphone in accordance with one embodiment of the invention, showing signal inputs and outputs;

FIG. 3 is a block diagram of the digital microphone in accordance with the preferred embodiment; and

FIG. 4 is a more detailed block diagram of an N^{th} order sigma-delta modulator, with single bit output stream.

### DETAILED DESCRIPTION OF THE PREFERRED EMBODIMENTS

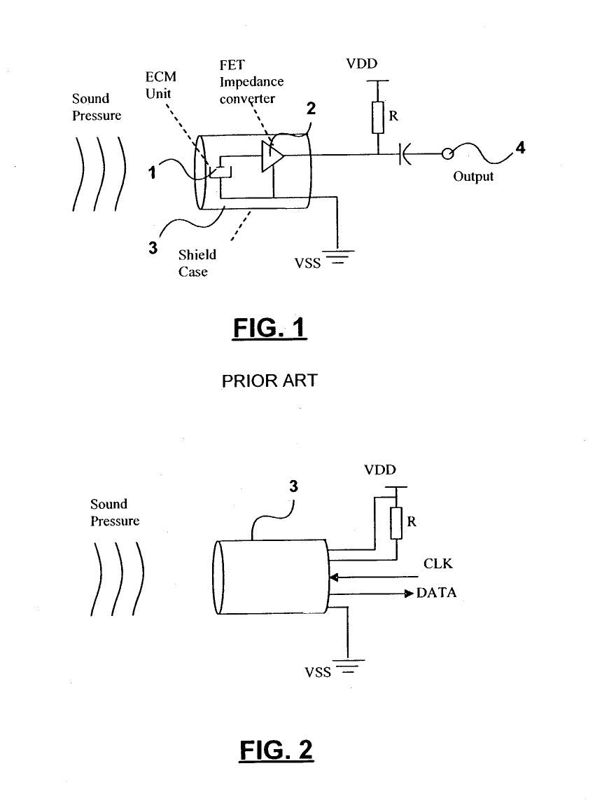

Referring now to FIG. 1, a conventional analog microphone comprises an Electret condenser microphone unit 1 is housed with an FET impedance converter 2 in a shield housing 3 and generates an output signal 4. An acoustic wave striking the active face of the microphone is converted into a corresponding electrical output signal.

FIG. 2 is a generic diagram of a digital microphone in accordance with the invention. As in FIG. 1, this includes an Electret microphone (not shown) and conversion circuitry for generating a data output single bit stream DATA at a rate set by a clock signal CLK.

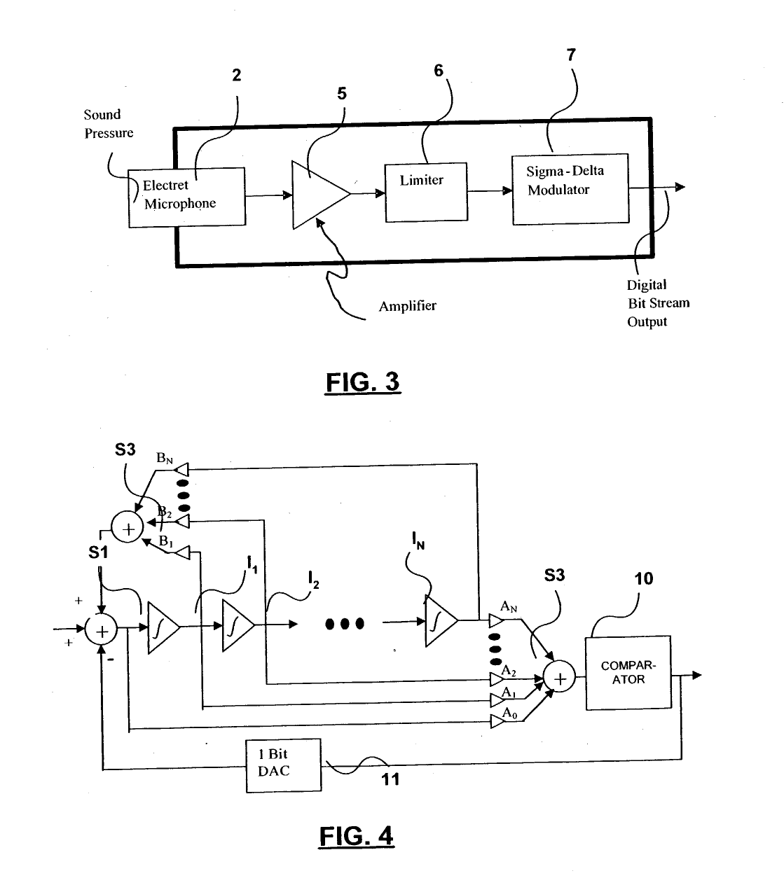

FIG. 3 is a block diagram of the components within the shield housing. Electret microphone is connected through an amplifier 5 to limiter 6. The output of limiter 6 is coupled to the sigma-delta modulator 7, which produces a digital single bit output stream 8.

In use the sound wave incident on the Electret microphone 2 is converted to an analog electrical signal, which is amplified in amplifier 5, limited in limiter 7, and converted to the digital output stream in the sigma-delta modulator 7.

FIG. 4 is a more detailed diagram of an N^{th} order sigma-delta modulator 7 (where N<1) with a single bit output stream. In FIG. 4, the input signal IN passes through summing node S1 to chain of integrators I₁, I₂, . . . I_{N}. The outputs of the integrators Iₙ are passed to the respective inputs Aₙ, Bₙ of summing nodes S2, S3. The output of summing node S3 is fed back as an input to the summing node S1. The output of the summing node S2 is passed through comparator 10 to produce the single bit digital output stream representing the analog signal. The output of the comparator 10 is passed through single bit digital-to-analog converter (DAC) 11 to the summing node S1.

The described microphone lends itself to integration. The amplifier, limiter and sigma-delta modulator can conveniently be integrated using larger geometry analog IC technology. The following digital circuits can be integrated as part of a “system-on-chip” (SOC) digital device using lower cost per gate, deep sub-micron digital IC technology.

A typical application for the digital microphone would be for a digital telephone or cellular phone, where the bit-rate of the serial output is not particularly important to minimize, since it has only to be connected to another digital IC or circuit. The digital serial output, being digital, alleviates noise ingress problems in the telephone (or other audio device). Other digital circuitry commonly associated with A/D conversion such as decimation filtering, and modulator quantization noise filtering, are not included in this digital microphone, and are left to be implemented in other digital devices that use deep sub-micron digital process technology more suited for digital circuits.

Further, many variants of single bit sigma-delta modulator A/D converter designs have subsequently been published and are well know to those skilled in the art of sigma-delta based A/D conversion.

1. A digital microphone comprising a transducer for generating an analog signal representing an acoustic signal; and a single bit sigma-delta modulator analog-to-digital converter of order greater than one for generating a digital output signal from said analog signal in the form of a sigma-delta modulated bit stream at an oversampled rate.

2. A digital microphone as claimed in claim 1, further comprising an amplifier and limiter connected between said transducer and said sigma-delta modulator.

3. A digital microphone as claimed in claim 2, wherein said an amplifier, limiter and sigma-delta modulator are provided on an integrated circuit using analog IC technology.

4. A digital microphone as claimed in claim 3, wherein said transducer and said integrated amplifier, limiter and sigma-delta modulator are provided in a common microphone housing.

5. A digital microphone as claimed in claim 1, wherein said sigma-delta modulator generates a digital output signal at an over-sampled rate N*F, wherein N is the number of bits per sample and F is the assumed final sample rate of the acoustic signal.

6. A digital microphone as claimed in claim 1, wherein said transducer is an Electret transducer.

7. A digital microphone as claimed in claim 1, wherein said sigma-delta modulator comprises a first summing node having an output connected to a chain of integrators, and output of each integrator being connected to respective inputs of second and third summing nodes, and output of said third summing node being connected to an input of said first summing node, an output of said second summing node being connected to a single bit analog-to-digital converter producing a single bit output stream, an output of said second summing node being connected to an input of said first summing node, and an output of said analog-to-digital converter being connected through a digital-to-analog converter to another input of said first summing node.

8. A method of converting an acoustic input signal to a digital output signal, comprising:
converting said acoustic input signal to an analog electrical signal; and
converting said analog electrical signal to a digital signal with the aid of a single bit sigma-delta modulator analog-to-digital converter of order greater than one to generate a single bit digital output signal.

9. A method as claimed in claim 8, wherein said sigma-delta modulator generates said digital output signal at an over-sampled rate N*F, where N is the number of bits per sample and F is the assumed final sample rate of the acoustic signal.

10. A method as claimed in claim 8, wherein said analog signal is amplified and limited prior to being input to said sigma-delta modulator.

11. A method as claimed in claim 8, wherein said conversion takes place in a chain of integrators whose outputs are connected to respective inputs of first and second summing nodes providing feedback.
